(19) United States
(12) Patent Application Publication
(10) Pub. No.: US 2003/0182657 A1
(43) Pub. Date: Sep. 25, 2003

(54) Broadcasting receiver

(76) Inventor: Toru Shibusawa, Osaka (JP)

Correspondence Address: RADER FISHMAN & GRAUER PLLC, LION BUILDING, 1233 20TH STREET N.W., SUITE 501, WASHINGTON, DC, 20036, US

(21) Appl. No.: 10/389,757

(22) Filed: Mar. 18, 2003

(30) Foreign Application Priority Data
Mar. 22, 2002 (JP) 080992/2002

(51) Int. Cl. H04N 5/445

(52) U.S. Cl. 725/52; 725/44

(57) ABSTRACT

When a priority channel is set, a user tunes in on a channel to be the priority channel in a receiver. Priority channel registration processing is started in data broadcasting appended to the channel. The receiver acquires a telephone number of a broadcasting enterpriser device in data broadcasting, and connects a telephone thereto. The broadcasting enterpriser device acquires user information from the receiver, and stores in the receiver its broadcasting enterpriser code as the priority channel. Thereafter, the channel having the broadcasting enterpriser code is tuned in on when a TV is turned on.

### BACKGROUND OF THE INVENTION

### Field of the Invention

The present invention relates to a broadcasting receiver that receives a digital broadcasting wave and an analog broadcasting wave.

In a conventional broadcasting receiver, at the time of switching a received channel, the number of a channel after the switching is stored in a memory. When an operation for turning a television (TV) on is performed after the TV is turned off, processing is performed so as to tune in on the stored channel after the switching. Consequently, a channel on which a program is finally viewed (a last channel) appears on a screen when the TV is turned on.

When a channel UP/DOWN key is operated, channels are conventionally determined in ascending order or descending order. Assuming that a broadcasting station is assigned to each of the channels, as shown in FIG. 5 (a), when a user operates a channel UP/DOWN key provided in a remote control transmitter 10 while he or she is viewing a program on Channel 2, the channels are switched in the order as shown in FIG. 5 (b). Specifically, Channel 2 (general broadcasting), Channel 3 (BB TV), Channel 4 (CC broadcasting), . . . , Channel 12 (educational TV), and Channel 2 (general broadcasting) are tuned in on in this order when the UP key is operated, while being tuned in on in the reverse order when the DOWN key is operated. When the TV is changed from an OFF state to an ON state, as shown in FIG. 5 (c), the last channel is selected.

Even if the last channel appears on the screen when the TV is turned on, however, the channel is not necessarily liked by the user. Accordingly, a channel switching operation is performed in many cases after the operation for turning the TV on is performed. Even in the operation of the channel UP/DOWN key, the channels are not switched in the order liked by the user.

### SUMMARY OF THE INVENTION

In view of the foregoing circumstances, an object of the present invention is to provide a broadcasting receiver that makes it possible to receive a channel desired by a user (a priority channel) when a TV is turned on and further makes it possible to reliably grasp the channel (priority channel) received when the TV is turned on on the side of a broadcasting station or the like.

In order to solve the above-mentioned problem, a broadcasting receiver according to the present invention is characterized by comprising means for storing channel selection information related to a channel set as a priority channel; and means for performing processing for tuning in on the channel set as, the priority channel when a TV is turned on.

By such a configuration, the channel desired by a user (priority channel) is received when the TV is turned on.

The broadcasting receiver may be so configured that a plurality of priority channels are ordered and registered, processing for tuning in on the channel set as the first-priority channel is performed when the TV is turned on, and processing for tuning in on the channels in the order of their priorities is performed for a channel up/down operation.

The broadcasting receiver may further comprise communication means, and may be so configured that connection to a particular party is made in the communication means, the single priority channel or the first-priority channel is registered on the basis of information sent from the party, and at least user information for specifying a user is transmitted to the party.

Consequently, it is possible to set the channel (priority channel) received when the TV is turned on from the broadcasting station having the channel and reliably grasp the channel on the side of the broadcasting station.

The broadcasting receiver may be so configured that information related to an effective period sent from the party is stored, and an elapse of the effective period is judged on the basis of date information from clock means or date information obtained from a broadcasting wave.

In this configuration, the broadcasting receiver may be so configured that the setting of the single priority channel or the first-priority channel is released when the effective period has elapsed.

The broadcasting receiver may comprise means for registering the single priority channel or the first-priority channel and its effective period by a user's operation, and communication means, and may be so configured that connection to a particular party is made in the communication means, and the registration is unchangeable by a user until the effective period has elapsed after the single priority channel or the first-priority channel and the effective period and at least user information for specifying the user are transmitted to the party.

Also in such a configuration, the channel (priority channel) received when the TV is turned on can be reliably grasped on the side of the broadcasting station or the like.

The broadcasting receiver may be so configured that connection to the party is made in the communication means when an instruction to cancel the priority channel setting is received from the user, and the party is requested to cancel the priority channel setting, to release the setting of the priority channel.

The broadcasting receiver may comprise means for registering the single priority channel or the first-priority channel by a user's operation, means for storing the setting conditions from the past to the present of the single priority channel or the first-priority channel, and communication means, and may be so configured that connection to a particular party is made in the communication means, and the setting conditions from the past to the present of the single priority channel or the first-priority channel and at least user information for specifying a user is transmitted to the party.

In such a configuration, in a receiver on the side of a certain user, it can be known after the fact on the side of the broadcasting station that Channel ◯ ◯ is set as the priority channel for one month. This also makes it possible to reliably grasp the channel (priority channel) received when the TV is turned on on the side of the broadcasting station or the like.

The broadcasting receiver may be so configured that information for making connection to the particular party is extracted from a broadcasting wave.

For example, it is possible to receive the channel having the digital broadcasting wave to be the priority channel and acquire information for the connection in data broadcasting appended to broadcasting on the channel.

The broadcasting receiver may comprise means for producing receiving quality information representing the receiving conditions of the channel, and may be so configured that the receiving quality information is transmitted to the party.

Therefore, it is possible to grasp the receiving conditions of a broadcasting service area on the side of the broadcasting station.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is an explanatory view showing the schematic configuration of a digital broadcasting system according to the present embodiment;

FIG. 2 is a block diagram showing a digital broadcasting receiver 30;

FIG. 3 is an explanatory view showing channel selection processing in a case where a priority channel is set; and

FIG. 4 is an explanatory view showing an example of processing among an advertiser, a broadcasting enterpriser, and a viewer.

### DESCRIPTION OF THE PREFERRED EMBODIMENTS

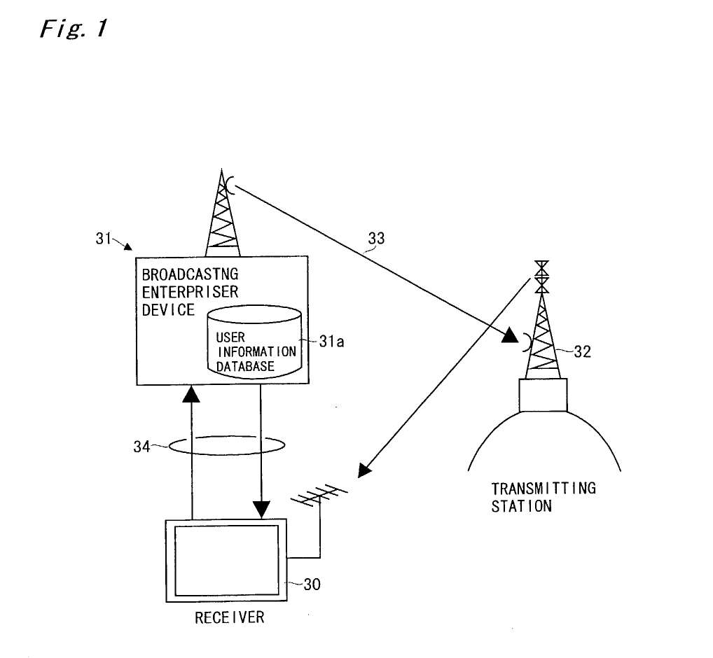

Although an embodiment of the present invention will be described on the basis of FIGS. 1 to 4, a case where a user views terrestrial wave digital broadcasting is herein illustrated.

In FIG. 1, a broadcasting enterpriser device 31 multiplies and modulates a program or programs, data broadcasting, a program guide, etc., date and time information, and information representing a modulation system or the like, and transmits the multiplexed and modulated data to a transmitting station 32 through a relay circuit (system) 33. The transmitting station 32 makes modulation adapted to the frequency of a broadcasting wave and a broadcasting system, and transmits a broadcasting wave from an antenna. The receiver 30 receives the broadcasting wave transmitted from the transmitting station 32.

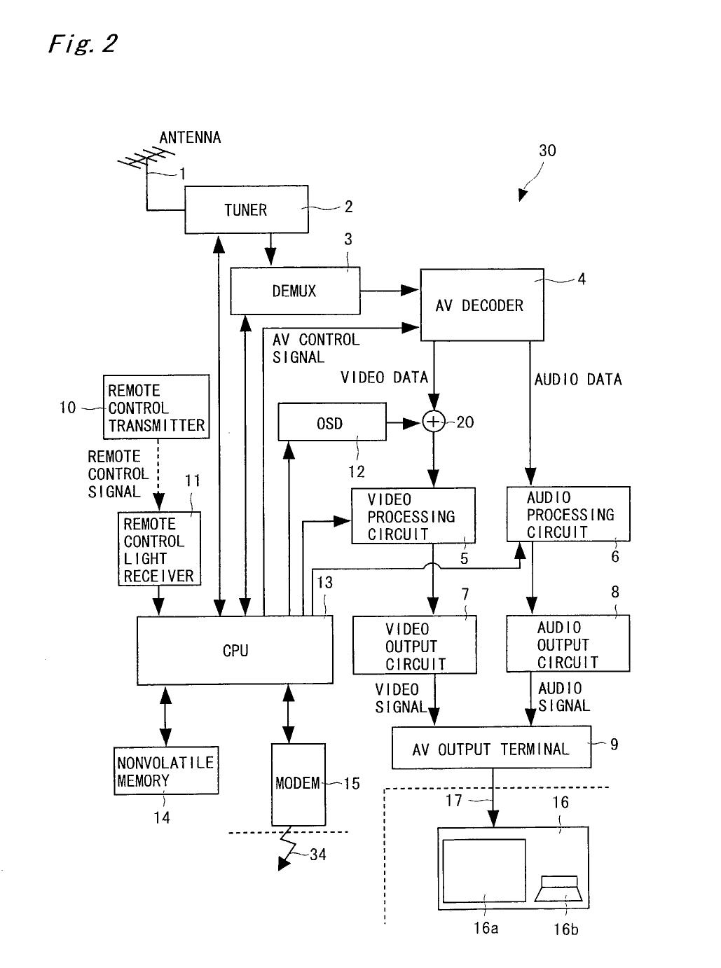

In terrestrial wave digital broadcasting, a plurality of broadcasting enterpriser devices 31 exist, to respectively broadcast their own programs on predetermined channels. A user information database 31a in the broadcasting enterpriser device 31 stores information related to a user who has set priority channels and information related to an effective period, etc. Further, the receiver 30 can be connected to the broadcasting enterpriser device 31 through a communication line 34 using a modem (see FIG. 2). An object to be connected to the receiver 30 is not necessarily limited to the broadcasting enterpriser device 31. For example, it may be a device provided in a commission agent of the broadcasting enterpriser device 31 or an association (a registration center, etc.) of a plurality of broadcasting stations.

FIG. 2 is a block diagram showing the receiver 30.

An antenna 1 receives the digital broadcasting wave sent from the transmitting station 32.

A tuner 2 extracts, out of high-frequency digital modulation signals including video/audio data, the signal having a particular frequency. Further, the tuner 2 comprises a demodulation circuit, an inverse interleave circuit, an error correcting circuit, and so on, thereby demodulating the selected digital modulation signal to output a transport stream.

A demultiplexer (DEMUX) 3 separates the transport stream into a video stream and an audio stream based on MPEG2 (Moving Picture Experts Group2) and PSI/SI (Program Specific Information/Service Information). The demultiplexer 3 feeds the video stream and the audio stream to an AV decoder 4, and feeds to a CPU 13 program information (the name of a program, the time when the program begins, information related to the contents of the program, information related to the genre of the program, etc.), for example, included in the PSI/SI. A plurality of services are multiplexed on the transport stream. Processing for selecting any of the services can be performed by extracting from the above-mentioned PSI/SI data indicating which packet ID in the transport stream is used to multiplex the arbitrary service. Further, the transport stream (a transponder) can be selected on the basis of the information in the PSI/SI.

The AV decoder 4 comprises a video decoder for decoding the video stream and an audio decoder for decoding the audio stream. The video decoder decodes an inputted variable length code to find a quantization factor and a motion vector, thereby carrying out inverse DCT (Discrete Cosine Transformation) and motion compensation control based on the motion vector, for example. The audio decoder decodes an inputted coded signal, to produce audio data. Video data produced by the decoding is outputted to a video processing circuit 5, and the audio data is outputted to an audio processing circuit 6.

The video processing circuit 5 receives the video data from the AV decoder 4 and subjects the received video data to digital-to-analog (D/A) conversion, to convert the video data into a composite video signal, for example. The audio processing circuit 6 receives the audio data outputted from the AV decoder 4 and subjects the received audio data to digital-to-analog (D/A) conversion, to generate an analog signal of a right (R) sound and an analog signal of a left (L) sound, for example.

Each of a video output circuit 7 and an audio output circuit 8 comprises an output resistor, an amplifier, and so on. An AV output terminal 9 is provided with an output unit (a set of a left/right audio output terminal or the like and a video output terminal or the like), and a monitor 16 comprising a CRT (Cathode Ray Tube) 16a and a speaker 16b is connected to the output unit by a video/audio code 17.

An OSD (On-Screen Display) circuit 12 outputs to an adder 20 video data based on character information or color information which it is instructed to output from the CPU 13. The adder 20 performs processing for incorporating the above-mentioned video data into the received video data outputted from the AV decoder 4. By the OSD circuit 12, display of an EPG (Electronic Program Guide) based on the above-mentioned program information received by the CPU 13 and display of various messages, for example, can be performed.

A remote control transmitter 10 is a transmitter for sending out a command to the broadcasting receiver 30. When a key (not shown) provided in the remote control transmitter 10 is operated, signal light (a remote control signal) meaning a command corresponding to the key is sent out from a light emitting unit (not shown). A remote control light receiver 11 receives the signal light, converts the received signal light into an electric signal, and feeds the electric signal to the CPU 13. A user can switch channels in the receiver 30 and enter user information utilizing the remote control transmitter 10.

A nonvolatile memory (e.g., EEPROM (Electrically Erasable and Programmable ROM)) 14 stores information related to a priority channel, information related to an effective period, etc. in addition to data (program information) for displaying an EPG screen.

A modem 15 is used for dial-up connection in a case where the user information is transmitted to the broadcasting enterpriser device 31 at the time of setting the priority channel. Further, it is used for utilizing interactive service in data broadcasting.

Although the CPU 13 carries out overall control in the digital broadcasting receiver 30, priority channel setting processing, described below, is particularly performed as control according to the present invention.

First, priority channel setting processing performed by direct setting from a user will be described below. For example, when an item “setting of a priority channel” is displayed on a menu screen, and the item is selected by a user's remote control operation or the like, an input frame of a channel number and buttons such as an “OK button” and a “cancel button” are displayed. When a numeral is inputted to the input frame by the user's remote control operation or the like, and the “OK button” is operated, the numeral is recorded on the nonvolatile memory 14 as a priority channel number. Thereafter, channel selection processing for not taking a channel in a case where the TV is turned off (a last channel) as a channel in a case where the TV is turned on but taking the priority channel recorded on the nonvolatile memory 14 as a channel in a case where the TV is turned on is performed. An operation for turning the TV off may be erroneously performed, to perform an operation for turning the TV on immediately after noticing that the operation for turning the TV off is erroneously performed. In this case, it is considered that a program which is being currently viewed is continuously viewed. When a time period elapsed from the time when the operation for tuning the TV off is performed is measured, and the operation for turning the TV on is performed before a predetermined time period has elapsed, therefore, the TV may be turned on on the last channel, as in the conventional example. Further, a plurality of priority channels may be ordered and registered, to perform processing for tuning in on the channel set as the first-priority channel when the TV is turned on and perform processing for tuning in on the channels in the order of their priorities for a channel up/down operation (this will be described in detail later).

Meanwhile, each of broadcasting stations will desire that a channel of its own is set to a priority channel, as described above, and consider that a service such as a prize may be performed for a user who has set the channel of its own to the priority channel. In this case, however, there is a disadvantage in that confirmation that the channel of the broadcasting station is actually set to the priority channel is not obtained in notification that the priority channel is set by a postcard or the like from the user. If the priority channel is set for the receiver 30 from the broadcasting station, the disadvantage can be overcome. A method of overcoming the disadvantage will be described.

When the priority channel is set, the user tunes in on a channel to be the priority channel in the receiver 30. Not only an original program but also data broadcasting appended thereto can exist on the channel. A priority channel registration menu (not shown) can be displayed in the data broadcasting. At this time, the receiver 30 acquires a telephone number of the broadcasting enterpriser device 31 from data broadcasting, dials the telephone number using the modem 15, and connects to the broadcasting enterpriser device 31.

The broadcasting enterpriser device 31 transmits to the receiver 30 a user information input screen including input items such as name, post code, address and telephone number and further including attribute information such as sex, age and hobbies serving as arbitrary items (the user information input screen (an XML (Extensible Markup Language) file) can be also given by data broadcasting). The receiver 30 which has received the user information input screen displays the user information input screen. The user uses the remote control transmitter 10 or the like, to enter user information. The receiver 30 transmits, when it transmits the user information to the broadcasting enterpriser device 31, the user information in addition to its inherent information (serial number, ID, etc.). The broadcasting enterpriser device 31 receives the information, to register the information in the user information database 31a. Further, the broadcasting enterpriser device 31 transmits a broadcasting enterpriser code (channel number) of its own. The receiver 30 receives the broadcasting enterpriser code (channel number), to store the broadcasting enterpriser code in the nonvolatile memory 14 as a priority channel (or a first-priority channel). Further, the broadcasting enterpriser device 31 also transmits a telephone number of its own. The receiver 30 receives the telephone number, to store the telephone number and the priority channel (broadcasting enterpriser code) as a set in the nonvolatile memory 14. The telephone number is used in processing for canceling the priority channel (this will be described in detail later).

Here, an effective registration period, for example, [one month], [three months], or [six months] can be also selected on the user information input screen, for example. Of course, the effective registration period can be also a fixed effective registration period, for example, one year. The broadcasting enterpriser device 31 shall transmit information related to the selected or fixed effective registration period in transmitting the broadcasting enterpriser code (channel number) of its own. The receiver 30 receives the information related to the effective registration period, to store the effective registration period information in the nonvolatile memory 14.

The receiver 30 informs, when another broadcasting enterpriser code has already been stored as a priority channel in the nonvolatile memory 14 and is within an effective period, the user that the broadcasting enterpriser code has already been registered by displaying on the screen “a priority channel has already been set to Channel ◯◯”. Further, the receiver 30 inquires the user whether or not the broadcasting enterpriser code which has already been registered should be canceled by displaying the inquiry on the screen. When the cancellation of the registration is selected, the telephone number (the telephone number of the broadcasting enterpriser device) recorded together with the broadcasting enterpriser code which has already been registered is used, to make line-connection to the broadcasting enterpriser device 31 having the broadcasting enterpriser code which has already been registered and automatically perform processing for canceling the registration. Thereafter, the above-mentioned processing for registering the priority channel is performed again.

Furthermore, the receiver 30 feeds to the broadcasting enterpriser device 31 status information representing the receiving conditions of the channel (a C/N (Carrier-to-Noise) ratio, an error rate, etc. obtained from the tuner 2) in the above-mentioned processing for registering the priority channel. The broadcasting enterpriser device 31 can grasp the receiving conditions in a broadcasting service area by using information related to the position of the receiver based on the post code, the address, the telephone number, etc. in the above-mentioned user information and the above-mentioned status information. Further, the broadcasting enterpriser device 31 can also grasp, when it can obtain the attribute information such as the sex, the age and the hobbies serving as the arbitrary items, information as to what type of people likes the channel of its own. Particularly when specialization of channels progresses, information as to what type of people likes each of the channels is important.

Supplementary explanation will be made in relation to the above-mentioned effective period. It can be judged whether or not the broadcasting enterpriser code is within the effective period by comparing the effective registration period information stored in the nonvolatile memory 14 with the current date obtained by decoding the date and time information multiplexed on the digital broadcasting wave or the like. When it is judged that the effective period has elapsed, the user may be informed that the effective period has elapsed by displaying on the screen the fact that the effective period has elapsed, or the broadcasting enterpriser code may be deleted from the nonvolatile memory 14. The effective period is also managed on the side of the broadcasting enterpriser device 31. When the effective period has elapsed, the fact that the effective period has elapsed is recorded. On the side of the broadcasting enterpriser device 31, various types of services corresponding to the lengths of the effective period can be also performed for the user, or various types of approaches can be also made to the user at the timing of the elapse of the effective period. The services and the approaches can be made by mail to an individual receiver using the digital broadcasting wave.

The priority channel is set such that not the last channel but the channel set by the user is a channel in a case where the TV is turned on, as described above. In this sense, the number of priority channels is one. On the other hand, the channel can be selected by not only pressing a numeric key in the remote control transmitter 10 but also pressing a channel UP/DOWN key. In view of the operation of the channel UP/DOWN key, it is also considered that a plurality of priority channels, for example, the first-priority channel, the second-priority channel, . . . are set.

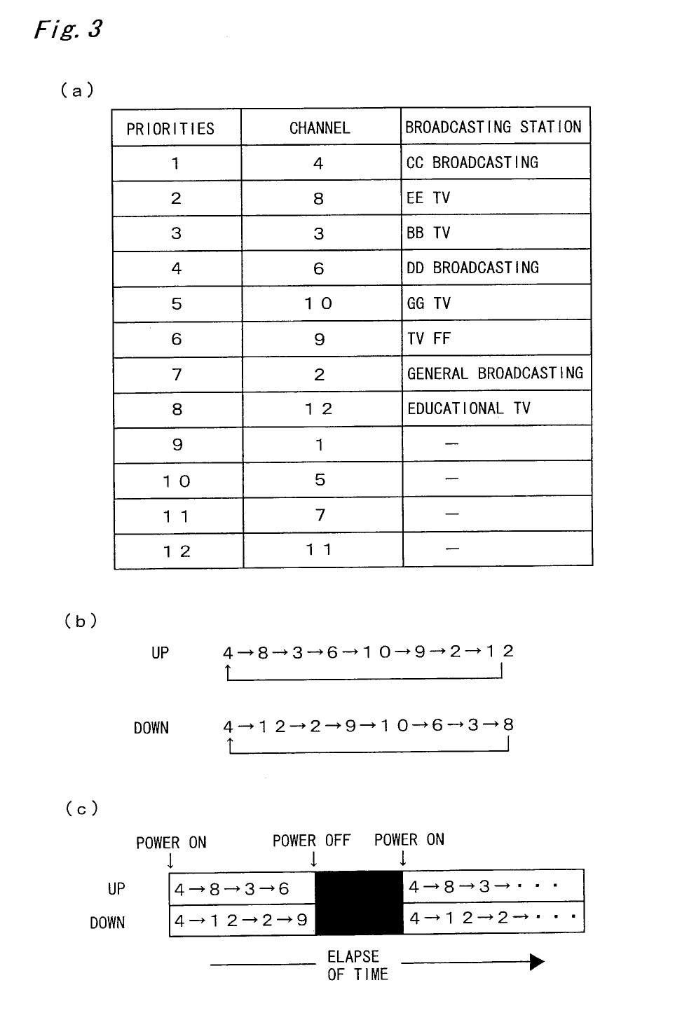

A case where the plurality of priority channels, for example, the first-priority channel, the second-priority channel, . . . are set will be described on the basis of FIG. 3. FIG. 3 (a) illustrates an example of priorities respectively assigned to the channels. Here, Channel 4 is taken as the first-priority channel. When the TV is turned on, Channel 4 is selected. When the channel UP/DOWN key provided in the remote control transmitter 10 is operated by the user while a program on Channel 4, for example, is being viewed, the CPU 13 switches the channels in the order as shown in FIG. 3 (b). Specifically, Channel 4 (CC broadcasting), Channel 8 (EE TV), Channel 3 (BB TV), . . . , Channel 12 (educational TV), and Channel 4 (CC broadcasting) are tuned in on in this order when the UP key is operated, while being tuned in on in the reverse order when the DOWN key is operated. When the TV is changed from an OFF state to an ON state, as shown in FIG. 3 (c), Channel 4 is selected.

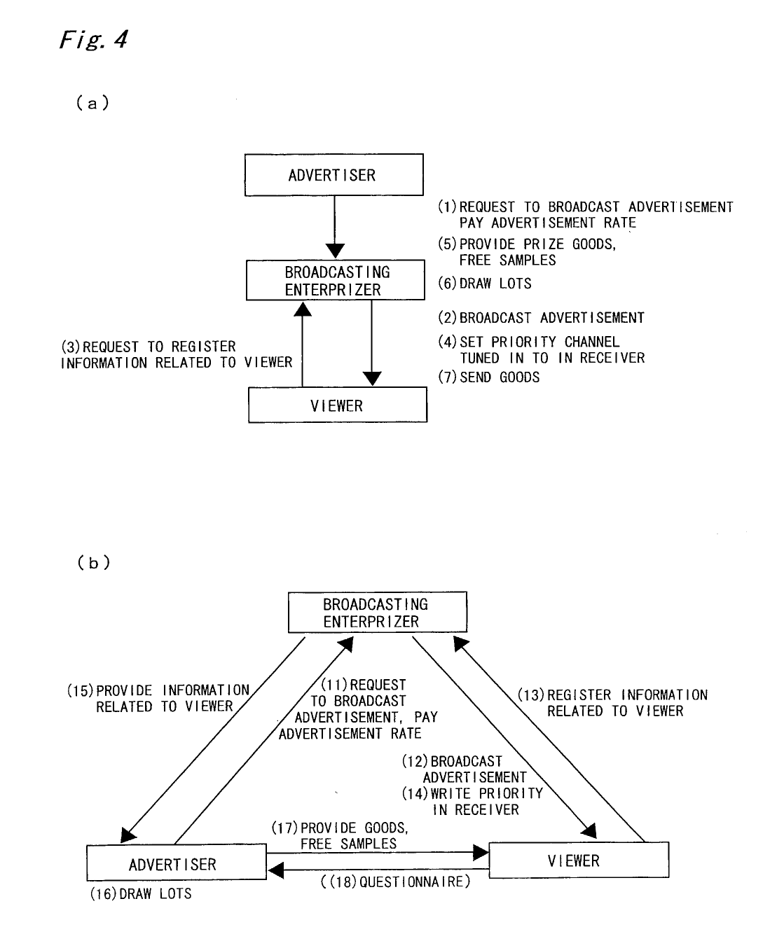

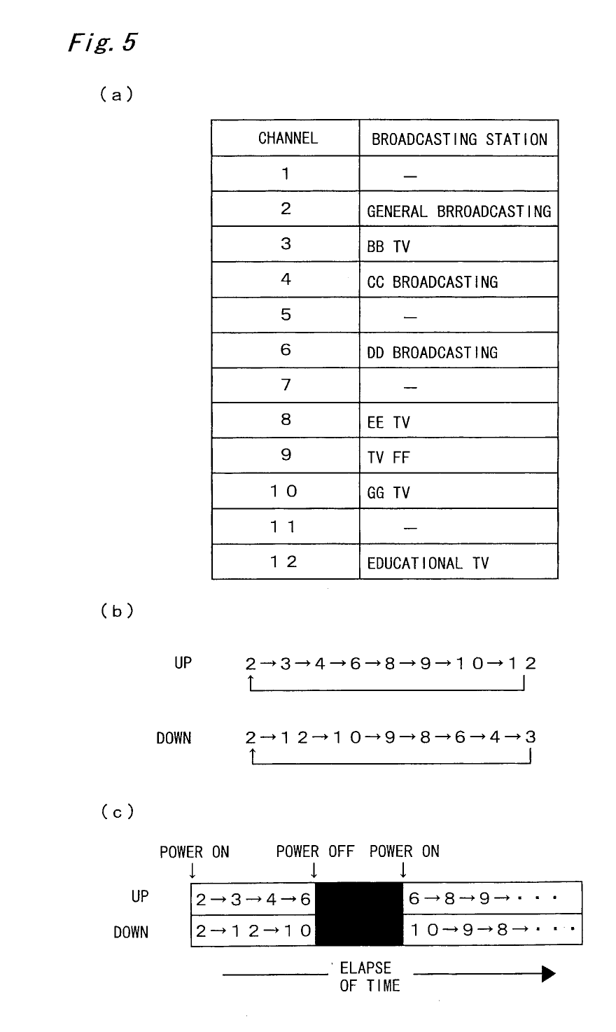

FIG. 4 is an explanatory view showing an example of processing among an advertiser, a broadcasting enterpriser, and a viewer. In FIG. 4 (a), when (1) the advertiser requests the broadcasting enterpriser to broadcast an advertisement by paying an advertisement rate, (2) the broadcasting enterpriser broadcasts the advertisement, to obtain an advertisement revenue. When (3) the viewer registers in the broadcasting enterpriser a priority channel tuned in on, (4) the broadcasting enterpriser sets a priority channel tuned in on in the receiver. (5) The advertiser delivers to the broadcasting enterpriser prize goods or free samples which are provided to a person who has set the priority channel tuned in on. (6) The broadcasting enterpriser draws lots on the basis of the user information in the user information database 31a, and (7) sends the goods to the viewer who has won the prize.

In FIG. 4 (b), when (11) the advertiser requests the broadcasting enterpriser to broadcast an advertisement by paying an advertisement rate, (12) the broadcasting enterpriser broadcasts the advertisement, to obtain an advertising revenue. When (13) the viewer registers in the broadcasting enterpriser a priority channel tuned in on, (14) the broadcasting enterpriser sets a priority channel tuned in on in the receiver. (15) The broadcasting enterpriser provides to the advertiser the user information in the user information data base 31a. (16) The advertiser draws lots, and (17) sends prize goods or free samples to the viewer who has won the prize. (18) The viewer who has been provided with the goods may submit a questionnaire to the advertiser. In this case, information related to the viewer is exposed to the advertiser. Accordingly, such a form that the viewer participates in prize drawing by his or her desire may be employed.

Although in the above-mentioned example, the single priority channel or the first-priority channel is set by communication for the receiver 30 from the broadcasting station or the like, the present invention is not limited to the same. For example, the single priority channel or the first-priority channel and its effective period may be registrable by a user's operation. Connection to a particular party (a registration center, etc.) is made using the modem 15, to transmit to the party the single priority channel or the first-priority channel and the effective period and at least the user information for specifying the user, and not to change the registration by the user until the effective period has elapsed after the transmission. Also in such a configuration, it is possible to reliably grasp the channel (priority channel) received when the TV is turned on on the side of the broadcasting station or the like.

Furthermore, the single priority channel or the first-priority channel may be registrable by a user's operation, and the setting conditions from the past to the present of the single priority channel or the first-priority channel may be previously stored in the memory 14. Connection to the particular party (the registration center, etc.) is made using the modem 15, to transmit to the above-mentioned party the setting conditions from the past to the present of the single priority channel or the first-priority channel and at least the user information for specifying the user. In such a configuration, it can be known after the fact on the side of the broadcasting station or the like that Channel ◯◯ is set as the priority channel for one month in a receiver on the side of the user. Consequently, the channel (priority channel) received when the TV is turned on can be reliably grasped on the side of the broadcasting station or the like.

As described in the foregoing, in the digital broadcasting receiver according to the present invention, the user can immediately view the desired channel when the TV is turned on. The channels are also switched in the preferred order even in the channel up/down operation. Further, in a configuration in which the priority channel can be set from the broadcasting enterpriser, for example, the channel (priority channel) received when the TV is turned on can be reliably grasped on the side of the broadcasting station or the like. Further, various types of information can be also obtained from each receiver.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. A broadcasting receiver, comprising:
means for storing channel selection information related to a channel set as a priority channel; and
means for performing processing for tuning in on the channel set as said priority channel when a television is turned on.

2. The broadcasting receiver according to claim 1, wherein
a plurality of priority channels are ordered and registered,
processing for tuning in on the channel set as the first-priority channel is performed when the television is turned on, and
processing for tuning in on the channels in the order of their priorities is performed for a channel up/down operation.

3. The broadcasting receiver according to claim 1, further comprising
communication means,
connection to a particular party being made in the communication means,
the single priority channel being registered on the basis of information sent from said party, and
at least user information for specifying a user being transmitted to the party.

4. The broadcasting receiver according to claim 2, further comprising
communication means,
connection to a particular party being made in the communication means,
the first-priority channel being registered on the basis of information sent from said party, and
at least user information for specifying a user being transmitted to the party.

5. The broadcasting receiver according to claim 3, wherein
information related to an effective period sent from said party is stored, and
an elapse of the effective period is judged on the basis of date information from clock means or date information obtained from a broadcasting wave.

6. The broadcasting receiver according to claim 4, wherein
information related to an effective period sent from said party is stored, and
an elapse of the effective period is judged on the basis of date information from clock means or date information obtained from a broadcasting wave.

7. The broadcasting receiver according to claim 5, wherein
the setting of the single priority channel is released when the effective period has elapsed.

8. The broadcasting receiver according to claim 6, wherein
the setting of the first-priority channel is released when the effective period has elapsed.

9. The broadcasting receiver according to claim 1, further comprising
means for registering the single priority channel and its effective period by a user's operation, and
communication means,
connection to a particular party being made in said communication means, and
the registration being unchangeable by a user until said effective period has elapsed after said single priority channel and the effective period and at least user information for specifying the user are transmitted to said party.

10. The broadcasting receiver according to claim 2, further comprising
means for registering the first-priority channel and its effective period by a user's operation, and
communication means,
connection to a particular party being made in said communication means, and
the registration being unchangeable by a user until said effective period has elapsed after said first-priority channel and the effective period and at least user information for specifying the user are transmitted to said party.

11. The broadcasting receiver according to claim 3, wherein
connection to the party is made in the communication means when an instruction to cancel the priority channel setting is received from the user, and
the party is requested to cancel the priority channel setting, to release the setting of the priority channel.

12. The broadcasting receiver according to claim 4, wherein
connection to the party is made in the communication means when an instruction to cancel the priority channel setting is received from the user, and
the party is requested to cancel the priority channel setting, to release the setting of the priority channel.

13. The broadcasting receiver according to claim 9, wherein
connection to the party is made in the communication means when an instruction to cancel the priority channel setting is received from the user, and
the party is requested to cancel the priority channel setting, to release the setting of the priority channel.

14. The broadcasting receiver according to claim 10, wherein
connection to the party is made in the communication means when an instruction to cancel the priority channel setting is received from the user, and
the party is requested to cancel the priority channel setting, to release the setting of the priority channel.

15. The broadcasting receiver according to claim 1, further comprising
means for registering the single priority channel by a user's operation,
means for storing the setting conditions from the past to the present of said single priority channel, and
communication means,
connection to a particular party being made in said communication means, and
the setting conditions from the past to the present of said single priority channel and at least user information for specifying a user being transmitted to said party.

16. The broadcasting receiver according to claim 2, further comprising
means for registering the first-priority channel by a user's operation,
means for storing the setting conditions from the past to the present of said first-priority channel, and
communication means,
connection to a particular party being made in said communication means, and
the setting conditions from the past to the present of said first-priority channel and at least user information for specifying a user being transmitted to said party.

17. The broadcasting receiver according to claim 3, wherein
information for making connection to said particular party is extracted from a broadcasting wave.

18. The broadcasting receiver according to claim 4, wherein
information for making connection to said particular party is extracted from a broadcasting wave.

19. The broadcasting receiver according to claim 9, wherein
information for making connection to said particular party is extracted from a broadcasting wave.

20. The broadcasting receiver according to claim 10, wherein
information for making connection to said particular party is extracted from a broadcasting wave.

21. The broadcasting receiver according to claim 15, wherein
information for making connection to said particular party is extracted from a broadcasting wave.

22. The broadcasting receiver according to claim 16, wherein
information for making connection to said particular party is extracted from a broadcasting wave.

23. The broadcasting receiver according to claim 3, further comprising
means for producing receiving quality information representing the receiving conditions of the channel,
said receiving quality information being transmitted to said party.

24. The broadcasting receiver according to claim 4, further comprising
means for producing receiving quality information representing the receiving conditions of the channel,
said receiving quality information being transmitted to said party.

25. The broadcasting receiver according to claim 9, further comprising
means for producing receiving quality information representing the receiving conditions of the channel,
said receiving quality information being transmitted to said party.

26. The broadcasting receiver according to claim 10, further comprising
means for producing receiving quality information representing the receiving conditions of the channel,
said receiving quality information being transmitted to said party.

27. The broadcasting receiver according to claim 15, further comprising
means for producing receiving quality information representing the receiving conditions of the channel,
said receiving quality information being transmitted to said party.

28. The broadcasting receiver according to claim 16, further comprising
means for producing receiving quality information representing the receiving conditions of the channel,
said receiving quality information being transmitted to said party.
